(19) United States
(12) Patent Application Publication
(10) Pub. No.: US 2004/0132463 A1
(43) Pub. Date: Jul. 8, 2004

(54) Method for transmitting position data relating to a moving object

(76) Inventors: Andreas Berg, Berlin (DE); Klaus Monele, Berlin (DE)

Correspondence Address: MORRISON & FOERSTER LLP, 1650 TYSONS BOULEVARD, SUITE 300, MCLEAN, VA, 22102, US

(21) Appl. No.: 10/636,779

(22) Filed: Aug. 8, 2003

(30) Foreign Application Priority Data
Aug. 13, 2002 (DE) 102 37 563.1

(51) Int. Cl. H04Q 7/20

(52) U.S. Cl. 455/456.1

(57) ABSTRACT

A method for transmitting position data relating to a moving object, in which a partial mobile communication call is set up from a mobile communication terminal, connected to the object, to a control node in the mobile communication network and is used to transmit the position data from the mobile communication terminal to the mobile communication network. The control node then terminates the partial mobile communication call, and the position data are detected using the mobile communication network and are forwarded to a reception computer.

### ClAIM FOR PRIORITY

This application claims priority to International Application No. 10237563.1 which was filed in the German language on Aug. 13, 2002, which is hereby incorporated by reference.

### TECHNICAL FIELD OF THE INVENTION

The invention relates to a method for transmitting position data relating to a moving object, in which the position data are transmitted using a mobile communication network to a reception computer which can perform data evaluation.

### BACKGROUND OF THE INVENTION

Transmission of position data is disclosed in “Cargo aktuell—Das Kundenmagazin für Transport und Logistik” [Cargo today—The customer magazine for transport and logistics], No 1, February 2001, published by DB Cargo AG, page 10 of the article entitled “Transportüberwachung aus dem A11” [Transport monitoring from the A11]. This known method involves freight trucks in a train being equipped with GPS (Global Positioning System) units which use the known satellite navigation system GPS to ascertain position data for the trucks in question. These position data are then transmitted to a reception computer in a GSM (Global System for Mobile Communications) mobile radio network in the form of an SMS (Short Message Service) message, and the reception computer evaluates the transferred data.

German laid-open specification DE 100 18 999 A1 discloses a method for providing location information in which a service control center in an intelligent network forwards a USSD message to that visitor location register VLR/MSC with which a mobile radio subscriber had his last contact with the network. The network then attempts to forward the USSD message to the mobile radio subscriber; it performs paging. If the location is successfully ascertained, a location information item is updated in the visitor location register.

Patent specification DE 697 14 232 T2 discloses a method relating to remote requesting of SIM data via a non-call-related link which involves a network-external USSD node user transmitting a USSD message intended for a mobile station to a home location register in a mobile communication network. The home location register then ascertains the current position of the mobile station, and the USSD message is transmitted to the mobile station.

In addition, German laid-open specification DE 196 51 110 A1 discloses a method for USSD positioning in which a location-dependent service application running in a mobile public home network HPLMN or in a visited public mobile country network VPLMN sends a USSD request for transmission of a location information item.

### SUMMARY OF THE INVENTION

The invention discloses a reliable and cost-effective operating method for transmitting position data relating to a moving object.

In one embodiment of the invention, there is a partial mobile communication call being set up from a mobile communication terminal, connected to the object, to a control node in the mobile communication network and being used to transmit the position data from the mobile communication terminal to the mobile communication network, the control node then terminating the partial mobile communication call, and the position data being detected using the mobile communication network and being forwarded to the reception computer.

In another embodiment of the invention, there is a mobile communication terminal connected to the object setting up a partial mobile communication call to a control node in the mobile communication network, the control node then terminating the partial mobile communication call, position data for the mobile communication terminal which are internal to the mobile communication network then being ascertained and being forwarded to the reception computer.

In still another embodiment of the invention, the communication terminal is able to evaluate a reaction by the control node to the partial mobile communication call in order to check directly whether the partial mobile communication call which has been set up has actually reached the control node. It is thus advantageously possible to ensure that information is transmitted between the mobile object and the permanently installed control node successfully. This is particularly an advantage over the initially mentioned prior art, since a sender of an SMS message is not able to determine whether and at what time this SMS message arrives at the intended receiver.

Another advantage of the invention is that termination of the partial mobile communication call by the control node means that the partial mobile communication call is terminated internally while it is still within the boundaries of the mobile communication network. Hence, a regular mobile communication call to a destination subscriber is not set up, which means that the mobile communication network is used only relatively briefly overall.

In yet another embodiment of the invention, there is a mobile communication terminal connected to the object transmitting a USSD string to the mobile communication network, the position data being transmitted with the USSD string from the mobile communication terminal to the mobile communication network, the mobile communication network being used to detect the position data, and then a control node in the mobile communication network forwarding the position data to the reception computer.

In another embodiment of the invention, there is a mobile communication terminal connected to the object transmitting a USSD string to the mobile communication network, position data for the mobile communication terminal then being ascertained internally in the mobile communication network and being transmitted to a control node, and the control node in the mobile communication network forwarding the position data to the reception computer.

For these two embodiments, the same advantages are obtained as for the other embodiments cited above. Specifically, the receiver's immediate reaction (“handshaking”) in mobile communication networks means that it is possible to see directly that the USSD string has reached its intended destination.

The embodiments may also be configured such that position data which have been ascertained by a satellite receiver arranged on the object are transmitted from the mobile communication terminal to the mobile communication network. Ascertaining the position data directly on the moving object has the advantage that the communication terminal arranged on the object can ensure, and possibly check, both the presence of the position data and correct despatch thereof to the mobile radio network.

In still another embodiment, position data for the mobile communication terminal which have been ascertained internally in the mobile communication network are transmitted to the control node. One advantage of this is that the position data ascertained internally in the network can be ascertained using network infrastructures and network devices which already exist in mobile radio networks. Such devices for ascertaining the position of a mobile communication terminal are normally available in mobile communication networks. Hence, in this embodiment of the invention, the moving object does not need to have a dedicated position finding device, which means that the methods can be implemented particularly cost-effectively.

In the embodiment above, the invention permits the position data ascertained internally in the network which are transmitted to be an identifier for a visitor location register which is responsible for the mobile communication terminal. In line with the invention, the identifier for the respective visitor location register is used as a position information item or as position data for the respective communication terminal; this is possible because each visitor location register (VLR) is responsible for mobile communication terminals in a particular geographical region. The position data ascertained internally in the network which are transmitted can also be an index (“Location Area”) for the area in which the mobile communication terminal is situated.

Similarly, the invention permits the position data ascertained internally in the network which are transmitted to be an identification sign for the mobile radio cell in which the mobile communication terminal is situated.

In still another embodiment of the invention, the control node used is a service control point in a mobile communication network having the structure of an intelligent network (IN). The service control point in an intelligent network can be used for carrying out or controlling the method in the mobile communication network easily and cost-effectively with very little complexity in terms of development and equipment.

In line with the invention, the reception computer can be in the form of part of the service control point. In this embodiment, the data evaluation can be performed within the intelligent network, which means that it is possible to dispense with additional hardware which would need to be connected to the intelligent network, for example.

The invention can involve the position data being transmitted to the reception computer at predetermined times.

In another embodiment of the invention, the position data are transmitted to the reception computer when the object reaches a predetermined location. In this embodiment, the number of data transmissions can advantageously be kept very low, since position data are transmitted when the object reaches one of these predetermined locations (e.g. a location which is “of interest” to the method operator).

The invention can also proceed such that the position data are transmitted from the mobile communication terminal to the reception computer after a stimulus message has been sent from the reception computer to the communication terminal via the mobile communication network in order to prompt data transmission. In this embodiment, the number of position data transmissions to be performed can be kept low, since such a transmission needs to be made only if the reception computer has a need for current position data and therefore this reception computer sends a stimulus message to the communication terminal. Both of the aforementioned embodiments of the invention allow a method which can be carried out cost-effectively on account of the small number of necessary data transmissions.

The moving objects can be associated with a transport vehicle. By way of example, such an object can be a transport container which is transported using a train wagon or using a transport motor vehicle (HGV). Similarly, the moving object can naturally be any moving article whose current position is of interest.

### BRIEF DESCRIPTION OF THE INVENTION

To explain the invention further, the figures show exemplary embodiments of the invention and are described below in detail, in which:

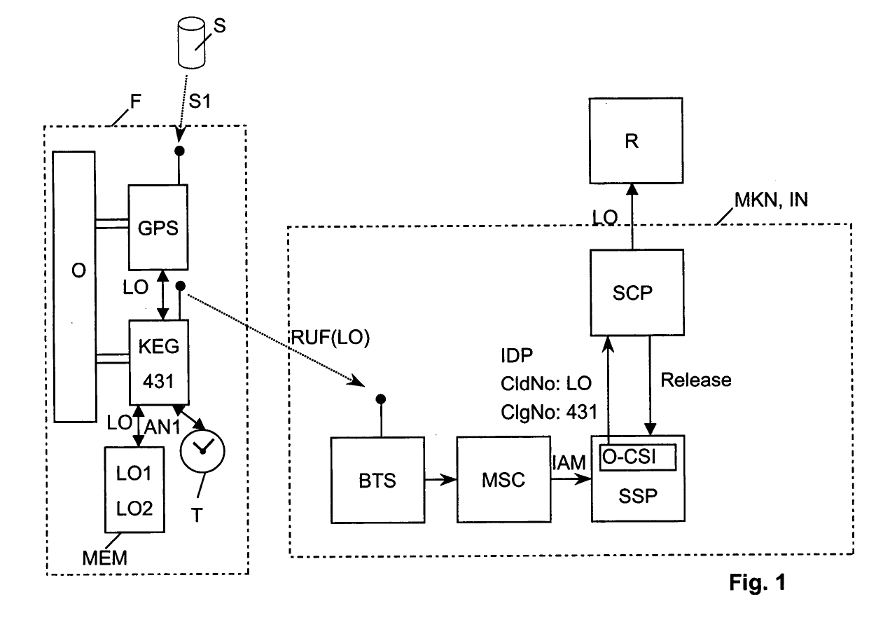

FIG. 1 shows a first exemplary embodiment of a method using satellite-assisted position data ascertainment.

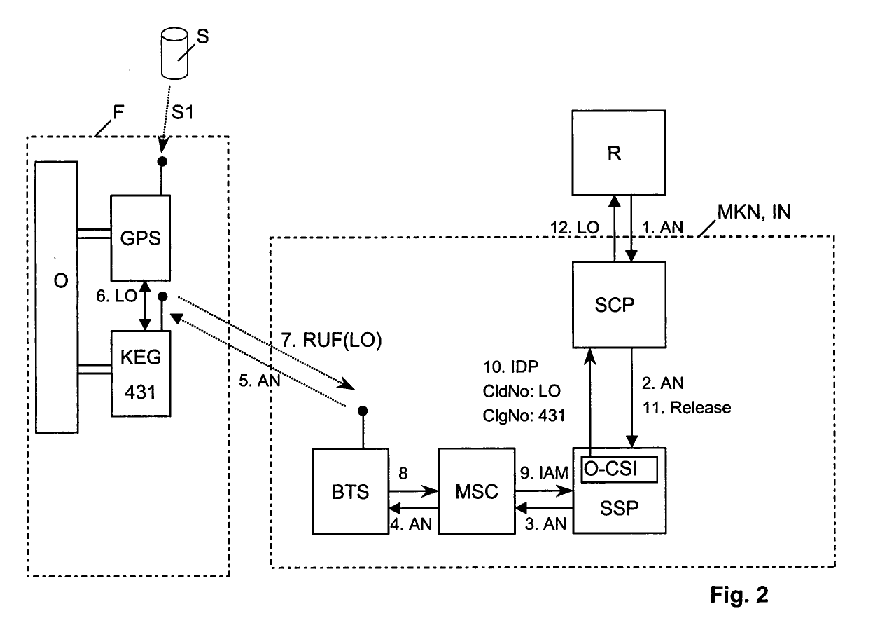

FIG. 2 shows a second exemplary embodiment of a method using satellite-assisted position data ascertainment.

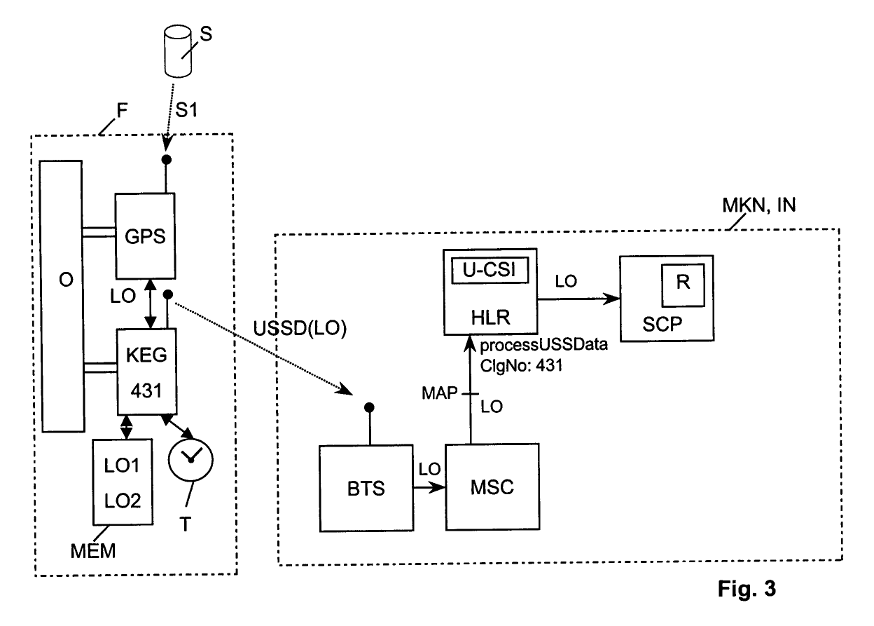

FIG. 3 shows a third exemplary embodiment of a method using satellite-assisted position data ascertainment.

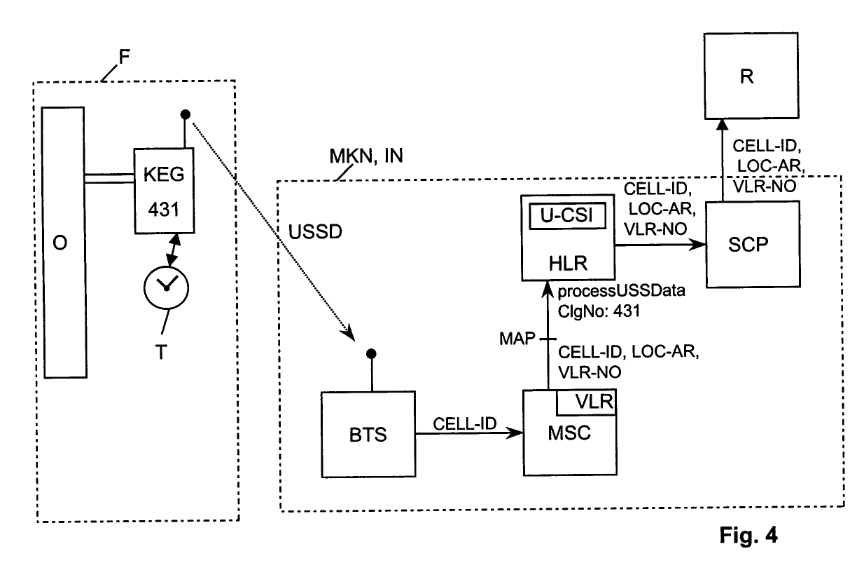

FIG. 4 shows an exemplary embodiment of a method using network-internal ascertainment of the position data.

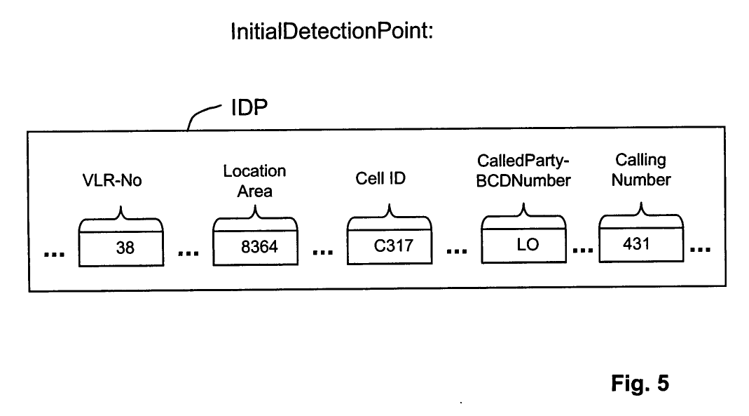

FIG. 5 shows an exemplary embodiment of a data message used within the context of the inventive methods.

### DETAILED DESCRIPTION OF THE INVENTION

The left-hand side of FIG. 1 shows a moving object O which is situated on board a transport vehicle F (e.g. a train wagon or an HGV). The moving object O is connected to a satellite receiver GPS and to a communication terminal KEG (e.g. a mobile radio module operating on the basis of the GSM, GPRS or UMTS standard). In this exemplary embodiment, the communication terminal KEG has an associated mobile radio call number “431”. The satellite receiver and the communication terminal can be connected to the moving object O mechanically, for example (the connection is symbolized by two parallel lines). Alternatively, the satellite receiver GPS and/or the communication terminal KEG can be installed in the vehicle F and can in this way be temporarily connected to the moving object. The satellite receiver GPS receives a satellite signal S1 from a satellite S and also further satellite signals (not shown) from further satellites (not shown), and uses these in a known manner to calculate position data (location data, position data) for the satellite receiver GPS, which are thus also position data for the object O. These position data LO are forwarded to the communication terminal KEG and are transmitted by the latter to a mobile communication network MKN shown schematically on the right-hand side of FIG. 1 using the communication terminal's radio interface. This mobile communication network MKN can be a mobile radio network based on the GSM, GPRS or UMTS standard, for example. Ascertainment of the position data LO and transmission of the position data to the mobile communication network can take place under time control at predetermined times or within predetermined time intervals. For this purpose, the communication terminal KEG is connected to a time control stage T. In another embodiment, the position data are ascertained and transmitted to the mobile radio network when the moving object O reaches a predetermined location. For this purpose, the communication terminal KEG is equipped with a memory comparator unit MEM. This memory comparator unit MEM stores predetermined position data LO1, LO2 etc. corresponding to the predetermined locations. The position data LO ascertained cyclically by the satellite receiver in this embodiment are compared in the memory comparator unit MEM with the predetermined position data LO1, LO2 etc. As soon as the currently ascertained position data LO match the predetermined position data LO1, LO2 (or the difference between the current position data LO and the predetermined, stored position data LO1, LO2 is below a defined threshold), the memory comparator unit MEM sends a stimulus signal AN1 to the communication terminal KEG, whereupon the latter transmits the currently ascertained position data LO to the mobile communication network MKN.

This transmission of the position data 10 is described below. To transmit the position data, the communication terminal KEG sets up a partial mobile communication call RUF to a control node SCP (Service Switching Point) in the mobile radio network MKN. In this exemplary embodiment, the mobile communication network MKN has the structure of an intelligent network (IN). Elements of this IN network structure are, inter alia, the aforementioned service control point SCP and a service switching point SSP. In addition, the mobile communication network MKN has a switching center MSC (Mobile Switching Center) and a base station BTS (Base Transceiver Station). The partial mobile communication call RUF used to transmit the position data LO to the communication network is routed in a known manner, like a normal mobile communication call, to the service switching point SSP via the air interface, the base station BTS and the switching center MSC. The position data LO are thus detected by the mobile communication network at the base station BTS. The air interface is used to transmit the position data upon connection set up, for example using the message “set up.” In this case, the position data can be transmitted using the data field which is provided for transmitting the destination call number of a destination subscriber external to the mobile communication network. To transmit the call data from the switching center MSC to the service switching point SSP, this exemplary embodiment uses the message “initial address message” (IAM). The service switching point SSP uses a known O-CSI (Originating Camel Subscription Information) trigger to identify that a partial mobile communication call RUF originating from the communication terminal KEG has arrived, and then sends a message “Initial Detection Point” (IDP) to the service control point SCP. This message IDP includes the mobile radio call number 431 of the communication terminal KEG as a sender information item (ClgNo=Calling Number). Since the partial mobile communication call has been sent to the control node SCP (e.g. a unit internal to the mobile radio network), and not to a “normal” B-subscriber addressable using a destination mobile radio call number, the data field for the destination call number (CldNo=Called Number) in the message IP is unused and is filled with the position data LO (transmitted with the partial mobile communication call RUF) in accordance with the invention. The service control point SCP receives the message IDP, ascertains the position data LO and the sender call number 431 from this message and forwards both the position data and the sender call number to a reception computer R which is connected to the mobile communication network MKN externally. On the basis of the position data LO and the call number 431, the reception computer R now has the information available regarding the position in which the object O, which is connected to the mobile communication terminal KEG, is currently situated.

When the service control point SCP has received the message IDP, e.g. has identified the partial mobile communication call RUF, it terminates the partial communication call RUF by sending a message “Release” to the service switching point SSP. The partial mobile communication call is thus terminated within the mobile communication network MKN and is ended as a result. This distinguishes it from a normal mobile communication call, which is forwarded to a destination subscriber external to the mobile communication network. Hence, for the partial mobile communication call RUF, an “A-Leg” is set up from the calling subscriber KEG to the mobile radio network, but no “B-Leg” from the mobile communication network to a called subscriber. Such partial mobile communication calls are also referred to as “call attempts”. These short “call attempts” place a slight load on the mobile communication network.

FIG. 2 shows a method sequence which differs from the method sequence explained in connection with FIG. 1 by virtue of the reception computer R stipulating the time at which position data LO for the mobile object are ascertained and transmitted to this reception computer R via the mobile communication network MKN. For this reason, the communication terminal KEG does not require the memory comparator unit MEM and the time control stage T shown in FIG. 1.

If the reception computer R requires position data for the object O, the reception computer R sends a stimulus message AN to the communication terminal KEG via the service control point SCP, the service switching point SSP, the switching center MSC and the base station BTS. This stimulus message prompts the communication terminal KEG to request the current position data from the satellite receiver GPS and to send them to the base station BTS in the mobile communication network MKN using the partial mobile communication call RUF. The rest of the sequence corresponds to the method sequence explained in connection with FIG. 1.

FIG. 3 shows another method sequence by way of example, in which the current position data LO for the moving object O are transmitted under time control (timer T) or under location control (memory comparator unit MEM) to the base station BTS in the mobile communication network MKN using a USSD string USSD. The message USSD is used to transmit the position data LO as signalling information to the mobile radio network, where they are detected by the base station BTS in the mobile communication network. Since signalling information can be transmitted to the mobile radio network in the form of a USSD string with little complexity, this specific type of data transmission allows a particularly cost-effective method for transmitting the position data. The information (including the position data LO) transmitted using the USSD string USSD is transmitted from the base station BTS in a known manner to the mobile radio switching center MSC, which transmits these data using an MAP message “ProcessUSSData” to a home location register HLR which exists in the communication network and is associated with the communication terminal KEG. This data transmission is controlled using a known “U-CSI-Trigger” U-CSI (USSD-Camel Subscription Information). The home location register HLR then forwards the position data to the service control point SCP. In this example, the position data LO also include information characterizing the moving object O, which means that the position data provide the SCP with the information regarding the geographical position at which the vehicle F with the moving object O is currently situated.

In this exemplary embodiment, the reception computer R is in the form of part of the service control point SCP. This has the advantage that the actual data evaluation requires no additional hardware in the form of an external reception computer R (as in the methods described in connection with FIGS. 1 and 2), but rather the service control point SCP which is present in the intelligent network anyway can also perform the data evaluation at the same time. This embodiment of the reception computer R ensures that the invention can be carried out with just low investment costs. The invention as described in connection with FIG. 1, 2 or 4 can also involve the reception computer R being in the form of part of the service control point SCP.

FIG. 4 shows an exemplary embodiment of the invention in which position data are ascertained internally in the mobile communication network MKN, are transmitted to the service control point SCP and are transmitted from the latter to the reception computer R. The mobile object O has the communication terminal KEG and the time control stage T available. At times prescribed by the time control stage T, the communication terminal KEG sends a USSD string USSD to the base station BTS in the mobile communication network. The base station BTS ascertains the mobile radio cell currently including the communication terminal KEG in a known manner, and forwards an identification sign for this mobile radio cell (a “Cell-ID”) to the switching center MSC as first position data. The switching center MSC has an associated visitor location register VLR which is responsible for the base stations in a particular geographical area. An identifier (the VLR number VLR-NO) for this visitor location register is used as a second position data item. In this exemplary embodiment, an index (“Location Area”) for the geographical area currently containing the mobile communication terminal KEG is additionally used as a further, third position data item. The switching center MSC now sends position data in the form of the identification sign CELL-ID for the mobile radio cell, the identifier VLR-NO for the visitor location register VLR and the index LOC-AR for the geographical area of the communication terminal to the home location register HLR together with the message “ProcessUSSData”. This home location register HLR transmits the position data CELL-ID, LOC-AR, VLR-NO to the service control point SCP, and the latter transmits them to the reception computer R. The use of the identification sign CELL-ID, the index LOC-AR and the identifier VLR-NO as position data for the moving object O is advantageous because these variables can easily be determined in a mobile communication network. Using these variables for a new purpose foreign to the mobile communication network, namely for position finding for moving goods, means that the moving goods 0 require no separate position finding system. Particularly with regard to the fact that it is often necessary to monitor the position of a large number of moving objects O, this embodiment of the invention allows a method which is extraordinarily cost-effective to implement as compared with the prior art cited in the introduction. It should be pointed out that transmitting just one data item among the aforementioned position data ascertained internally in the network (e.g. transmitting the identification sign CELL-ID or the index LOC-AR or the identifier VLR-NO) is also adequate, and it is in no way always necessary to transmit all three types of position data.

It will be expressly mentioned that the position data ascertained internally in the network, namely the identifier VLR-NO for the visitor location register VLR, the index LOC-AR for the geographical area and the identification sign CELL-ID for the mobile radio cell, can also be formed as position data and transmitted to the service control point SCP in the invention described in connection with FIGS. 1 to 3. In a similar manner to the two exemplary embodiments of the invention as illustrated in FIGS. 1 and 2, the position data determined internally in the network can also be transmitted from the service switching point SSP to the service control point SCP using the message IDP.

FIG. 5 shows a message IDP (Initial Detection Point), which is used in line with the invention for transporting the position data from the service switching point SSP to the service control point SCP. This message IDP includes, inter alia, the five data fields shown in FIG. 5. In a first data field “VLR-No”, the identifier (in this example “38”) for the visitor location register VLR currently responsible for the mobile communication terminal KEG is transmitted, in a second data field “Location-Area” the index (“8364”) for the area (Location Area) currently including the mobile communication terminal is transmitted, in a third data field “Cell-ID” the identification sign (“C317”) for the currently used mobile radio cell is transmitted, in a fourth data field “CalledPartyBCDNumber” the position data LO are transmitted, and in a fifth data field “Calling Number” the mobile radio call number (“431”) for the communication terminal KEG is transmitted as a sender address. In line with the invention, the fourth data field “CalledPartyBCDNumber” is not occupied by the call number of the called subscriber, but rather the position data LO (e.g. ascertained by the satellite receiver GPS) are entered into this data field.

Methods have been described which are used to transmit data describing the position of a mobile object O (position data) to a reception computer R for the purpose of data evaluation and position finding. Such position finding is significant for logistics companies, for example, which own a wagon park comprising HGVs or train wagons, for example. These logistics companies require the position of their vehicles, e.g. for their customers, who can use these data to observe progress of the delivery of the moving goods. Often, the vehicles in the wagon park also have a high value themselves, which means that the position information is of great benefit, e.g. in the event of accidents or theft (of the vehicles or the moving goods/objects). The position information can also be used to ascertain information about unused or resting vehicles and hence to achieve efficient wagon park planning.

What is claimed is:

1. A method for transmitting position data relating to a moving object, comprising:
transmitting the position data, using a mobile communication network, to a reception computer, which is configured to perform data evaluation;
setting up a partial mobile communication call from a mobile communication terminal, connected to the object, to a control node in the mobile communication network, which is used to transmit the position data from the mobile communication terminal to the mobile communication network;
terminating the partial mobile communication call via the control node; and
detecting the position data using the mobile communication network and forwarding to the reception computer.

2. A method for transmitting position data relating to a moving object, comprising:
transmitting the position data, using a mobile communication network, to a reception computer, which is configured to perform data evaluation;
setting up a partial mobile communication call, via a mobile communication terminal connected to the object, to a control node in the mobile communication network, the control node terminating the partial mobile communication call; and
internally determining the position data in the mobile communication network and are forwarding the position data to the reception computer.

3. A method for transmitting position data relating to a moving object, comprising:
transmitting the position data, using a mobile communication network, to a reception computer, which is configured to perform data evaluation;
transmitting, via a mobile communication terminal connected to the object, a USSD string to the mobile communication network;
transmitting the position data with the USSD string from the mobile communication terminal to the mobile communication network;
using the mobile communication network to detect the position data; and
forwarding, via a control node in the mobile communication network, the position data to the reception computer.

4. A method for transmitting position data relating to a moving object, comprising:
transmitting the position data, using a mobile communication network, to a reception computer, which is configured to perform data evaluation;
transmitting, via a mobile communication terminal connected to the object, a USSD string to the mobile communication network;
internally determining position data for the mobile communication terminal in the mobile communication network and are transmitting the position data to a control node; and
forwarding, via the control node in the mobile communication network, the position data to the reception computer.

5. The method as claimed in claim 1, wherein position data are transmitted which have been determined by a satellite receiver arranged on the object.

6. The method as claimed in claim 2, wherein the position data for the mobile communication terminal which have been determined internally in the network and are transmitted to the control node.

7. The method as claimed in claim 6, wherein the position data determined internally in the network which are transmitted are an identifier for a visitor location register which is responsible for the mobile communication terminal.

8. The method as claimed in claim 6, wherein the position data determined internally in the network which are transmitted are an index for the area in which the mobile communication terminal is situated.

9. The method as claimed in claim 6, wherein the position data determined internally in the network which are transmitted are an identification sign for the mobile radio cell in which the mobile communication terminal is situated.

10. The method as claimed in claim 1, wherein the control node used is a service control point in a mobile communication network having the structure of an intelligent network.

11. The method as claimed in claim 10, wherein the reception computer is in the form of part of the service control point.

12. The method as claimed in claim 1, wherein the position data are transmitted to the reception computer at predetermined times.

13. The method as claimed in claim 1, wherein the position data are transmitted to the reception computer when the object reaches a predetermined location.

14. The method as claimed in claim 1, wherein the position data are transmitted from the mobile communication terminal to the reception computer after a stimulus message has been sent from the reception computer to the communication terminal via the mobile communication network in order to prompt data transmission.

15. The method as claimed in claim 1, wherein the moving object is used which is associated with a transport vehicle.
